(19) United States
(12) Patent Application Publication
(10) Pub. No.: US 2014/0347363 A1
(43) Pub. Date: Nov. 27, 2014

(54) Localized Graphics Processing Based on User Interest

(71) Applicant: Nikos Kaburlasos, Lincoln, CA (US)

(72) Inventor: Nikos Kaburlasos, Lincoln, CA (US)

(21) Appl. No.: 13/899,685

(22) Filed: May 22, 2013

(51) Int. Cl. G06T 5/00

(52) U.S. Cl. CPC G06T 5/00
USPC 345/428; 345/418; 345/589

(57) ABSTRACT

In accordance with some embodiments, processing power is applied based on the user's detected level of interest. In one embodiment, the user's detected level of interest in particular regions within a frame may be determined using an eye gaze detector or eye tracking apparatus. Those frame regions or areas that the user spends more of his or her attention on may be processed faster, at higher resolution or otherwise to enhance their depiction.

### BACKGROUND

This relates generally to graphics processing.

Generally graphics processors use the same degree of precision in all areas across each graphics frame of a series of frames making up a moving picture. Thus, more processing power may be expended in processing regions of a frame that are more complex. As a result, the processing time may be different for different regions.

Sometimes one region of a frame or a series of frames is of more interest to the user than others. However, since all regions of the frame are processed using the same processing power, all regions are treated generally equally and so the more complex areas are processed more slowly and less complex areas are processed more quickly, regardless of the user's level of interest in those particular areas.

This application of processing power based on the nature of the content may result in delaying the user's ability to see the specific portions the user wants to see as well as in excessive power consumption in some cases.

### BRIEF DESCRIPTION OF THE DRAWINGS

Some embodiments are described with respect to the following figures:

FIG. 1 is a schematic depiction of one embodiment;

FIG. 2 is a depiction of a user interest area identification according to one embodiment;

FIG. 3 is a depiction of a user interest area identification according to another embodiment;

FIG. 4 is a depiction of a user interest area identification according to still another embodiment;

FIG. 5 is a flow chart for one embodiment;

FIG. 6 is a system depiction for one embodiment; and

FIG. 7 is a front elevational view of one embodiment.

### DETAILED DESCRIPTION

In accordance with some embodiments, processing power is applied based on the user's detected level of interest. In one embodiment, the user's detected level of interest in particular regions within a frame may be determined using an eye gaze detector or eye tracking apparatus. Those frame regions or areas that the user spends more of his or her attention on may be processed faster, at higher resolution or otherwise to enhance their depiction.

A wide range of future processing systems will include one or more always on cameras that support gesture based user input as well as other usages such as facial recognition and eye gaze tracking. Cameras embedded in such platforms may be active on a continuous basis to continuously track the user and enable appropriate responses by the platform to user gestural commands. Camera input processing may be power optimized so that it is done efficiently and does not impose a significant burden on platform energy use.

An always on camera may also be used in order to improve the performance and/or reduce power dissipation of graphics workloads and especially three-dimensional graphics workloads that execute on platforms. Those platforms can use camera inputs to determine whether the user is currently focusing his or her attention on a certain area of the display screen. If so, the vertices or pixels in these areas of focus may be processed more intensely around the area of focus and less intensely away from the area of focus.

In this way, the processor graphics (or graphics processing unit) expends more processing power to deliver higher quality graphics in areas of the screen that matter to the user, while expending less processing power working on other areas of the screen that matter less, because they are not at the user's current area of attention and are therefore less likely to be noticed by the user.

At the same, by expending less processing power on more complicated regions of less user interest, power consumption may sometimes be reduced. For example, the user may select a different screen after the region of interest is processed, avoiding the need to process the other regions of the screen.

Similar techniques may also be used on systems that do not have camera inputs. For example in touch based systems, the user's point of touch on the screen can be used as an indication of where the user's attention is currently focused and this input may be used in turn to guide the selection of areas for more intense processing.

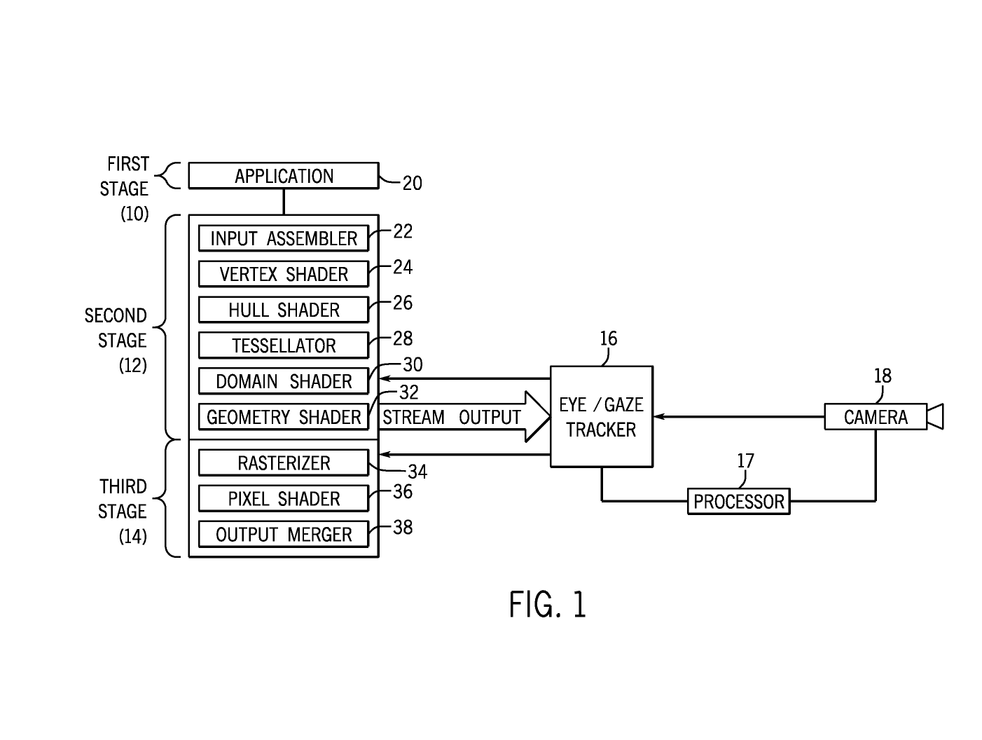

“Graphics processing” as used herein is divided into three stages. In the first stage 10, shown in FIG. 1, a graphics application 20 generates a number of vertices that model a number of objects in three-dimensional space. Light sources, textures and other structures have typically already been specified. In the second stage 12, also depicted in FIG. 1, vertices are processed. Vertex coordinates may be converted between different coordinate systems, and vertex attributes such as lighting are calculated. In a third stage 14, also shown in FIG. 1, vertices are mapped onto pixels and pixel processing occurs including texturing and blending. The second and third stages are often accelerated and performed on special purpose processor graphics. Processing vertices and pixels may involve significant amounts of computing in processor graphics and result in significant amounts of power dissipation.

In one embodiment, the second stage may include the input assembler 22, vertex shader 24, hull shader 26, tessellator 28, domain shader 30 and geometry shader 32. For example these components may be part of a Direct3D 11 pipeline.

The third stage may include the rasterizer 34 and pixel shader 36 that lead to an output merger 38.

An always on camera 18 may feed video to an eye or gaze tracker 16 that in turn provides information about the user's level of interest in particular areas on the display screen to the second stage 12 and third stage 14. A processor, such as a processor graphics, may control the camera 18 and receive information from the tracker 16.

The camera input may be used to reduce the amount of vertex and pixel processing required when rendering graphics. User attention may sometimes be focused on a particular area of the screen for a significant amount of time because that portion of the screen contains more action or is otherwise more worthy of the user's attention. Objects inside the user's area of focus may be rendered with the highest quality possible, because they are closely and carefully watched by the user. Conversely, objects away from the area of focus may not need to be rendered with the same quality, because the user is not currently focusing on the details of such objects anyway. The camera input can be used for gaze tracking purposes to help determine whether user's attention has been focused on a certain area of the screen for a certain amount of time. The amount of time that triggers the indication of user attention may be programmable in some embodiments.

When a new focus point has been identified on the screen, the processor graphics can spend more of its compute power on the vertices and pixels inside that area of focus and less for vertices and pixels outside that area of focus.

Of course a focus point may not always exist. For example, if the user's eyes keep scanning the entire screen for some amount of time and do not settle on a discernible area of the screen, then no focus point exists at that time and all vertices and pixels in the frame are processed normally.

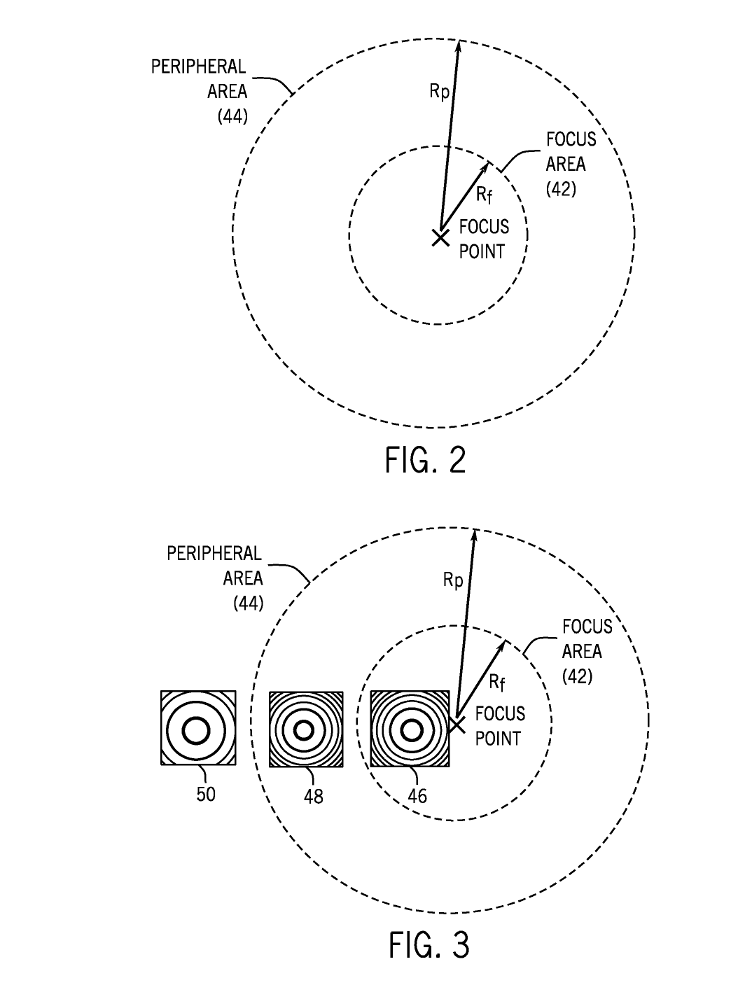

FIG. 2 illustrates an embodiment pertaining to vertex processing. FIG. 2 assumes that the user has focused attention around a focus point on the screen. Camera input and gaze tracking help identify the current focus point on the screen. Then the screen can be divided into three areas, a focus area 42 within the radius R_{f} from the current focus point, a peripheral area 44 that is outside the focus area but within Rₚ distance from the focus point and finally the rest of the screen that is outside of both the focus and the peripheral areas. The radii R_{f} and Rₚ may be determined as a function of overall screen area.

The values of R_{f} and Rₚ can be programmable and may vary from frame to frame.

As the user focuses attention on the current focus point, the user is closely watching objects inside the focus area and so these objects may be rendered with higher detail and quality. Therefore, all the vertices and triangles within the focus area may be preserved and processed by the graphics pipeline in one embodiment.

Conversely, objects in the peripheral area are not at the focus of attention currently but they are close enough that they too may be rendered with reasonable quality even if less than the quality of the regions of most interest. This is because user's peripheral vision may still notice objects in that peripheral area. And modest degradation of the visual representation of these objects may go unnoticed but a significant degradation may be discernible. As a result, a relatively small number of vertices and triangles of these objects may be dropped without affecting the perceived quality of the overall image.

Finally objects outside of both the focus and peripheral areas may be too far from the current focus point and a more significant degradation in their visual representation may be tolerated, since the user's gaze is currently not directed in the vicinity of such objects. Therefore more vertices and triangles may be dropped from the three-dimensional representation.

In a more general case, multiple concentric peripheral areas can be identified on the screen to achieve a more gradual transition from the focus area, where vertex and pixel processing is most intense, to the outermost area of the screen where vertex and pixel processing is the least intense.

This approach may allow for a significant reduction of the total number of vertices that have to be processed in the current frame in some embodiments. This reduction may lead to a measurable reduction of the workload as the processing unit typically needs to perform a number of operations on each vertex including coordinate conversion, lighting calculations and the like. Reducing the number of vertices to be processed reduces the computational load and thus the power dissipation of the processor graphics.

The same principles may also apply to pixel processing stage of the graphics pipeline. There are many different types of pixel processing that can be applied on a rendered image, including texture processing and pixel blending. As an example, consider texture processing while understanding that the same concepts also apply to other types of pixel processing. The general principle is that pixel processing can be more detailed or more intense closer to the current focus point of the screen and less intense further away from the focus point.

For example, textures are often applied onto three-dimensional objects, after rasterization, to enhance the visual impact of those objects. Higher quality textures use more texels for higher resolution. Texture filtering techniques are often applied to reduce aliasing. Mip-mapping is a popular texture processing technique that involves storing multiple versions or levels of detail of the same texture. Different levels of details have different texel resolutions and involve different numbers of texels. When a three-dimensional (3D) object appears nearer on the screen, a higher resolution version of the texture may be used to avoid aliasing effects. When the object resides further away from the screen, a lower resolution texture can be used. Linear interpolation between two neighboring levels of detail can also be performed, depending on how close or far into the screen the three-dimensional object appears.

Thus as shown in FIG. 3, the same object may be assumed to be rendered, at the same distance into the screen, either inside the current focus area or in the peripheral area or outside both. A certain texture is to be applied on the object and three levels of detail of that texture are available. As shown in FIG. 3, three levels of detail may be used, including flat textures that are not applied to any three-dimensional object for simplicity. Assuming that the three-dimensional object appears to be close to the viewer, the highest resolution level of detail may be used, to avoid aliasing. Indeed that level of detail is used if the object 46 is located inside the current focus area, as shown in FIG. 3. When the object 48 is outside the focus area, inside the peripheral area, then a lower resolution level of detail may be used. Of course this may lead to some aliasing but this is not very likely to be noticeable as the object is outside the current focus area. Lastly, if the object 50 is outside the peripheral area, the lowest resolution level of detail can be used. This level of detail may result in even greater aliasing, but is also not very likely to be noticed as the object is further away from the current focus point.

In general, picking lower resolution levels of details for objects that appear further and further away from the current focus point, can achieve a considerable reduction in the number of texels that are moved from texture caches and into samplers or other texture processing logic of a processor graphics, resulting in lower power dissipation.

Reducing the computational load as described herein, can reduce power dissipation and lead to extended battery life. For “heavy” graphics workloads that do not allow for any power down, then reducing the computational load on the processor graphics allows the processor to process more frames per second, leading to increased performance within a given power budget and may even allow for some additional power down residency, providing a battery life benefit. Therefore some embodiments may enhance both battery life and/or performance for processor graphics workloads.

In some embodiments, the camera driver may interact directly or indirectly via an operating system interface, for example with the graphics driver, and pass information to the graphics driver about the current focus point. This information helps to determine the focus and peripheral areas of the screen.

After vertex coordinates have been converted to the two-dimensional screen coordinate system, it is known whether a vertex is located in the focus or peripheral areas. As the processor graphics processes vertices, it can apply an algorithm to filter out some of the vertices or collapse some of the triangles that are located outside the focus or peripheral areas. Such filtering algorithms, with varying degrees of efficiency in terms of power saving or visual impact, may be applied to particular situations.

Referring again to the example of texture processing, in a common usage model, the graphics application provides the processor graphics with different levels of detail of the textures that are used and the graphics processing unit selects the appropriate level of detail (or pair of levels of detail plus interpolation) based on the distance of the object into the screen (or rather, based on the size of the triangles of the object after they are mapped to a number of pixels on the screen). If the processor graphics also knows whether a pixel it processes belongs to a focus area or the peripheral area or to neither of those, it can skew its level of detail selection towards the lower resolution if it knows that the pixel it renders is outside the focus area or outside both the focus and peripheral areas.

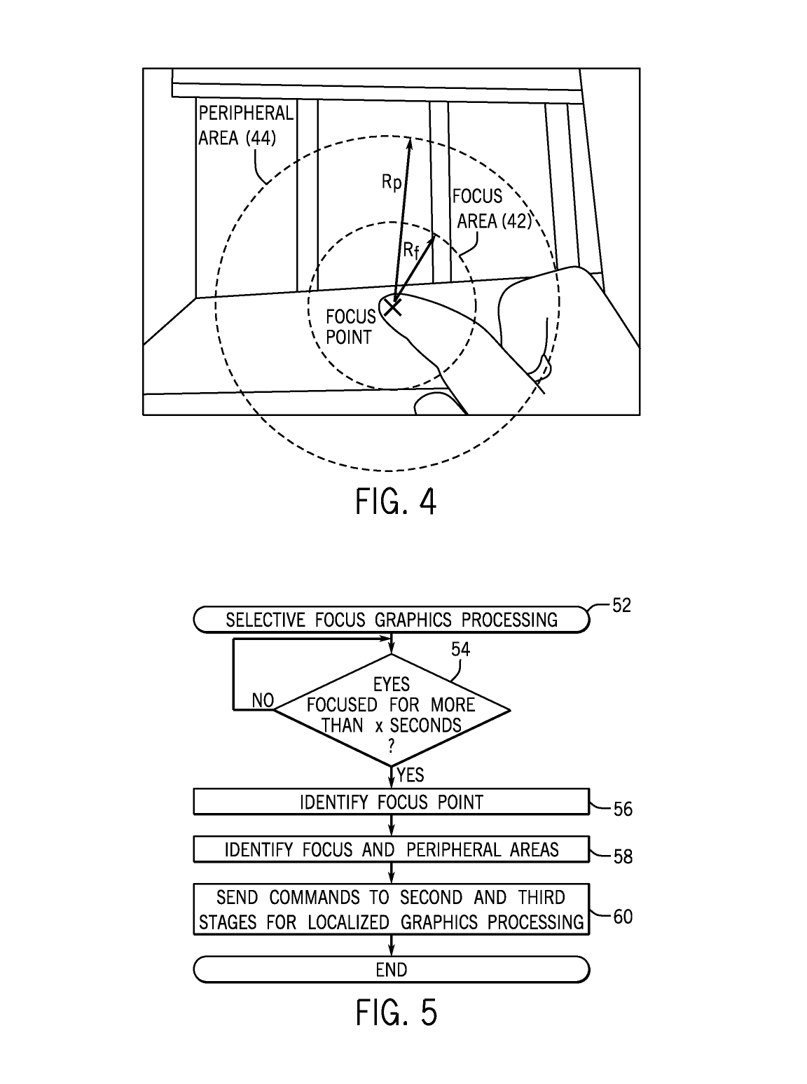

In addition, the user's area of greatest interest can be gauged in other ways. For example in touch enabled systems, the user can interact with a touch screen. Referring to FIG. 4, the user playing a game uses their finger to navigate inside a citadel or area surrounding it. The user touches the screen to point the direction where the user wants to move a playing piece. Obviously the touch point also provides an indication of the area on the screen where the user's attention is most focused and therefore can help in determining which portions of the screen vertex and pixel processing can be more or less intensive, based on the principles described herein. At times when the user is not touching the screen, vertex and pixel processing may be done fully on the entire screen, since the platform may have no indication of where the user is currently focused.

In the general case, a game user may be using another navigation device other than finger touching or touch enabled screens to navigate around a scene in a video game. A tracking device may help the user point to an area of interest or focus on the screen. Once that focus point is defined by the user via the navigation device (e.g. mouse or other pointing device), the same technique of selected focus rendering described earlier can be applied to reduce dissipation or improve performance in some embodiments.

Referring to FIG. 5, a sequence 52 for localized graphics processing may be implemented in software, hardware, and/or firmware. In software and firmware embodiments instructions stored in one or more non-transitory computer readable media such as an optical, magnetic or semiconductor storage may be executed by a processor to perform the sequence. For example, the instructions may be executed by the processor 17 (FIG. 1) coupled to the eye gaze tracker 16 and camera 18 in one embodiment.

The sequence 52 may begin by determining whether the user's eyes are focused for more than a predetermined amount of time on one particular point or region on the computer screen (diamond 54). This may be implemented in one embodiment using an eye tracker or gaze tracker. If the determination in diamond 54 is that the eyes are so focused, the flow continues to identify the focus point as indicated in block 56. Otherwise the flow simply waits until such a situation is determined.

Then in block 58, the focus and peripheral areas are identified using predetermined radii in one embodiment. Finally commands are sent to the second and third stages of a graphics processing pipeline for localized graphics processing as indicated in block 60.

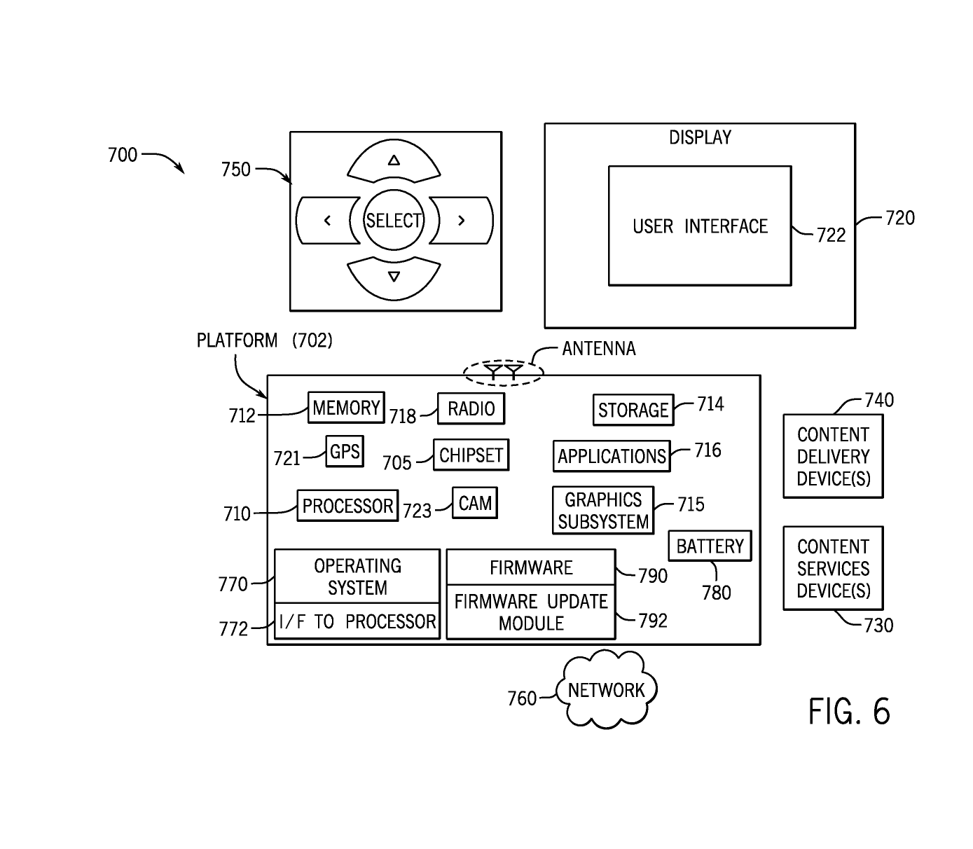

FIG. 6 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth. The processor may implement the sequence of FIG. 5 together with memory 712.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

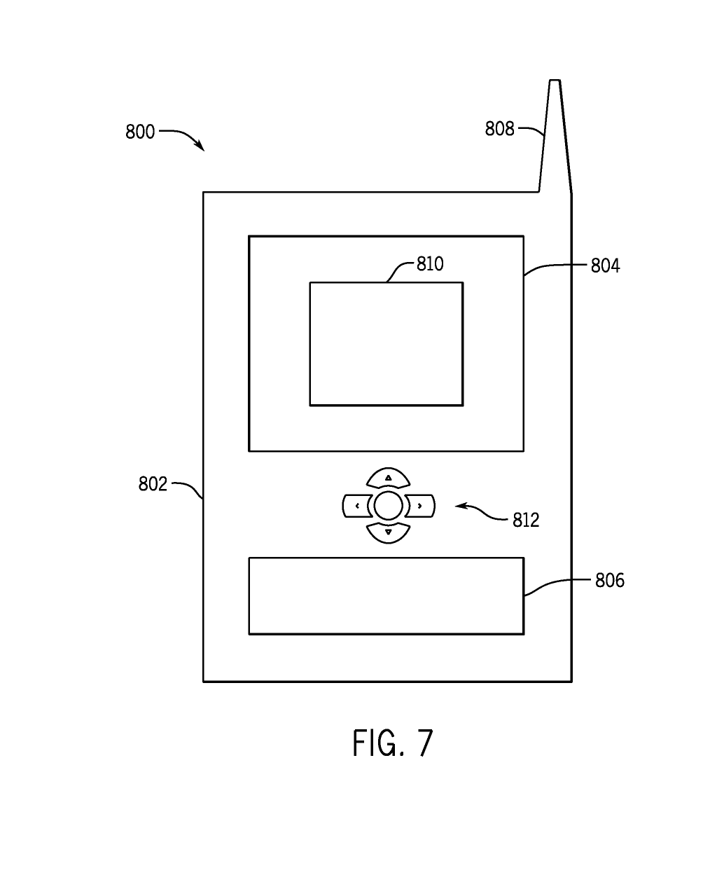

As described above, system 700 may be embodied in varying physical styles or form factors. FIG. 7 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The processor 710 may communicate with a camera 722 and a global positioning system sensor 720, in some embodiments. A memory 712, coupled to the processor 710, may store computer readable instructions for implementing the sequences shown in FIG. 5 in software and/or firmware embodiments.

As shown in FIG. 7, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this present disclosure.

What is claimed is:

1. A computer executed method comprising:
identifying an on-screen area of user interest; and
processing graphics associated with said area differently than another screen area is processed.

2. The method of claim 1 wherein processing differently includes providing higher resolution in the area of user interest than in the another screen area.

3. The method of claim 1 wherein processing differently includes dropping less triangles or vertices in the area of user interest than in the another screen area.

4. The method of claim 1 wherein processing differently includes processing faster in the area of user interest than in the another screen area.

5. The method of claim 1 including identifying an area of user interest using eye tracking.

6. The method of claim 5 including identifying an area of interest based on amount of time a user looked at an area on the screen.

7. The method of claim 6 including identifying a first area within a given distance of a focus point and a second area greater than the given distance and processing graphics differently in said first and second areas.

8. The method of claim 1 including changing at least one of shading and rasterizing based on an identification of an on-screen area of user interest.

9. One or more non-transitory computer readable media storing instructions to be executed by a processor to perform a sequence comprising:
identifying an on-screen area of user interest; and
processing graphics associated with said area differently than another screen area is processed.

10. The media of claim 9 wherein processing differently includes providing higher resolution in the area of user interest than in the another screen area.

11. The media of claim 9 wherein processing differently includes dropping less triangles or vertices in the area of user interest than in the another screen area.

12. The media of claim 9 wherein processing differently includes processing faster in the area of user interest than in the another screen area.

13. The media of claim 9, said sequence including identifying an area of user interest using eye tracking.

14. The media of claim 13, said sequence including identifying an area of interest based on amount of time a user looked at an area on the screen.

15. The media of claim 14, said sequence including identifying a first area within a given distance of a focus point and a second area greater than the given distance and processing graphics differently in said first and second areas.

16. The media of claim 9, said sequence including changing at least one of shading and rasterizing based on an identification of an on-screen area of user interest.

17. An apparatus comprising:
a storage; and
a processor coupled to said storage to identify an on-screen area of user interest and process graphics associated with said area differently than another screen area is processed.

18. The apparatus of claim 17, said processor to provide higher resolution in the area of user interest than in the another screen area.

19. The apparatus of claim 17, said processor to drop less triangles or vertices in the area of user interest than in the another screen area.

20. The apparatus of claim 17, said processor to process faster in the area of user interest than in the another screen area.

21. The apparatus of claim 17, said processor to identify an area of user interest using eye tracking.

22. The apparatus of claim 21, said processor to identify an area of interest based on amount of time a user looked at an area on the screen.

23. The apparatus of claim 22, said processor to identify a first area within a given distance of a focus point and a second area greater than the given distance and to process graphics differently in said first and second areas.

24. The apparatus of claim 17, said processor to change at least one of shading and to rasterize based on an identification of an on-screen area of user interest.

25. The apparatus of claim 17 further including a camera coupled to said processor.

26. The apparatus of claim 17 including an operating system.

27. The apparatus of claim 17 including a battery.

28. The apparatus of claim 17 including firmware and a module to update said firmware.
